(19) United States
(12) Patent Application Publication
(10) Pub. No.: US 2022/0019426 A1
(43) Pub. Date: Jan. 20, 2022

(54) METHOD DEVICE AND SYSTEM FOR UPGRADABLE MICROCODE (UCODE) LOADING AND ACTIVATION IN RUNTIME FOR BARE METAL DEPLOYMENT

(71) Applicant: Intel Corporation, Santa Clara, CA (US)

(72) Inventors: Chuan SONG, Shanghai (CN); Ruixia LI, Shanghai (CN); Murugasamy K. NACHIMUTHU, Beaverton, OR (US); Mohan J. KUMAR, Aloha, OR (US); Sarathy JAYAKUMAR, Portland, OR (US); Xiaojin YUAN, Shanghai (CN); Yidong WU, Shanghai (CN); Siyuan FU, Shanghai (CN); Feng JIANG, Shanghai (CN)

(21) Appl. No.: 17/393,300

(22) Filed: Aug. 3, 2021

(51) Int. Cl. G06F 8/656; G06F 9/455; G06F 9/445; G06F 8/654; G06F 9/48

(52) U.S. Cl. CPC G06F 8/656; G06F 9/45541; G06F 9/485; G06F 8/654; G06F 9/44589

(57) ABSTRACT

Methods, apparatus, and systems for upgradable microcode (uCode) loading and activation in runtime for bare metal deployments that support runtime update of the uCode loading procedure as well as dynamic load of activation procedure(s) specific to uCode patch and activation policy specific to users. The solution provides several advantages, including enabling cloud service providers to hot-patch the uCode through a standalone uCode loader runtime service in BIOS firmware for bare metal deployment without tenant system involvement. The support of runtime update of uCode loading procedures decouples uCode loading logic from uCode loader framework. This removes dependencies on the uCode loader runtime service when needing to update the uCode loading logic.

### BACKGROUND INFORMATION

The use of cloud-hosted services and applications has exploded in the past decade and continues to grow at an exponential rate. Cloud-hosted services and applications are generally implemented in large data centers housing thousands of compute platforms such as servers, blade servers, server modules, micro-servers, etc. Oftentimes, the platforms are configured as virtualized execution used for hosting virtual machines and “containers” or the like in which software applications are run.

Each platform includes physical hardware, firmware (also referred to as BIOS—Basic Input-Output System), and software. The root of trust for the platform is the platform hardware and firmware, which although less susceptible to malicious actors that software still may pose a risk. For security and other reasons (e.g., performance), platform firmware may need to be updated.

Historically, the BIOS in personal computer (PC) platforms was a monolithic block of code that was installed in Read-Only Memory (ROM), wherein BIOS was updated by replacing the BIOS ROM chip. Subsequently, the BIOS was installed in EEPROM (Electrically Erasable Programmable Read-Only Memory) and could be replaced (in its entirely) via a firmware update. In approximately 1998, Intel® Corporation began development of a modular firmware architecture known as the Extensible Firmware Interface (EFI). In 2005, the Unified EFI forum was formed as an industry-wide organization to promote adoption and continue the development of the EFI Specification. Using the EFI 1.10 Specification as the starting point, this industry group released began releasing firmware specifications, renamed Unified EFI (UEFI). UEFI firmware dominates today's platform architectures. UEFI firmware has a modular architecture that includes a core block to which modules are added, wherein the core block is booted first, and the booted code is used to load the modules during platform boot. Also, rather than EEPROMs, most of today's firmware is stored in flash memory (sometimes referred to as BIOS flash and referred to as persistent flash memory). More generally, platform firmware may be stored in a non-volatile storage device, which includes but is not limited to flash memory and EEPROMs.

Under some platform architectures, bootloaders may be used to load platform firmware. For example, bootloaders are used for mobile devices and some server platforms.

Traditionally, the uCode updates can be loaded into CPU (central processing unit, aka processor) either by boot time loading (if the uCode update corresponds to pre-boot uCode that is loaded prior to booting an operating system) or by operating system execution time loading (referred to as a hot-upgrade or run-time uCode update). Cloud environments are sensitive to system downtime caused by system firmware upgrades and the cloud service providers prefer the hot-upgrade method to load uCode patch through operating system utility in runtime if the uCode update does not have dependencies to the boot phase of platform hardware and operating system.

Cloud service providers provide a variety options for tenants, including virtualized environments under which the service provider provides and operating system and hypervisor or VMM (virtual machine monitor) on which tenant-managed virtual machines (VMs) are run and “bare” metal platforms under which the cloud service provider leases the hardware on which tenant VMs are run without a host operating system provided by the service provider. An example of a bare metal cloud environment 100 is shown in FIG. 1, which includes a cloud service provider environment 102 and a tenant environment 104. Cloud service provider environment 102 includes a managed platform 106 including one or more host CPUs 108 and BIOS SPI (Serial Peripheral Interface) flash 110. Cloud service provider environment 102 also includes BIOS firmware (FW) 112.

Tenant environment 104 includes a host operating system 114 on which one or more applications 116 are run. For illustrative purposes, tenant environment is further depicted as including a uCode hot-upgrade utility 118 that would be used to support uCode hot-upgrades during operating run-time for a virtual environment that wasn't bare metal. Under bare metal environment 100, host operating system 114 is owned by a single tenant instead of the cloud service provider. This makes it much more complex for cloud service providers to facilitate uCode updates using hot-upgrade methods for tenant-owned operating system environments, such as illustrated for tenant environment 104. In particular, uCode hot-upgrade utility 118 cannot update uCode using an in-band method in bare metal cloud environment 100.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a cloud service provider environment employing a bare metal cloud environment include a managed bare metal platform hosting a tenant environment, and further illustrating that an in-band uCode hot-upgrade method is not workable for such an environment;

FIG. 2 is a diagram illustrating the structure of a uCode capsule image, according to one embodiment;

FIG. 3 is a process flow diagram used to perform a hot-upgrade of uCode, according to one embodiment;

FIG. 4 is a diagram illustrating an exemplary structure for a uCode loader runtime service, according to one embodiment;

FIG. 5 is a flowchart illustrating operations and logic for implementing authentication flow for a patch stub update module, according to one embodiment;

FIG. 6 is a schematic diagram illustrating an embodiment of a uCode hot-upgrade method used to upgrade uCode on one or more CPUs using an out-of-band controller during host OS runtime, according to one embodiment;

FIG. 6a is a schematic diagram illustrating an alternative platform configuration under which a uCode capsule is received by a BMC on which BMC firmware is stored and executed, according to one embodiment;

FIG. 7 is a block diagram illustrating a high-level view of the uCode hot-upgrade process, according to one embodiment; and

FIG. 8 is a schematic diagram of an exemplary bare metal platform architecture on which embodiments disclosed herein may be implemented.

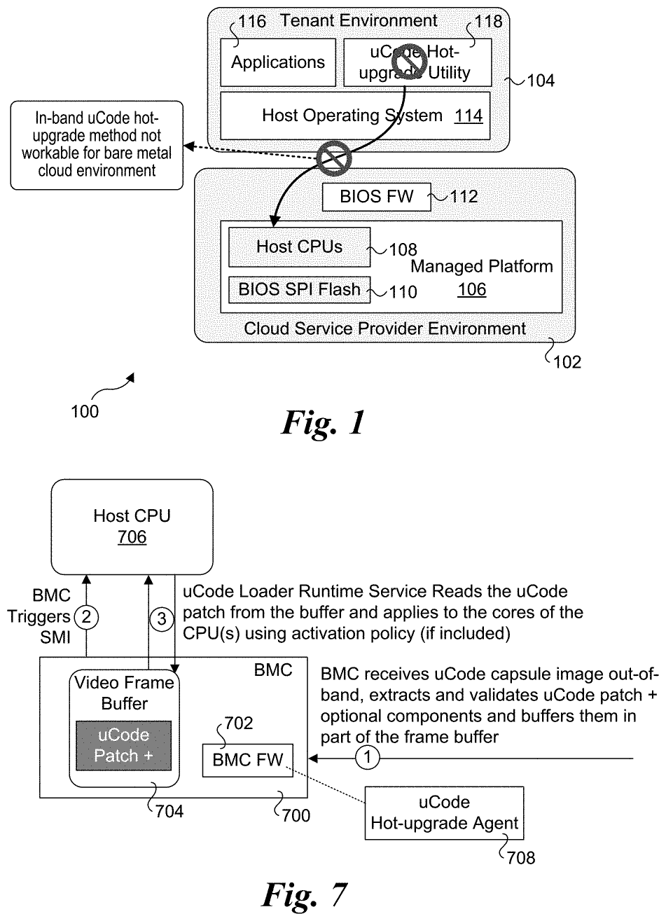

### DETAILED DESCRIPTION

Embodiments of methods, apparatus, and systems for upgradable microcode (uCode) loading and activation in runtime for bare metal deployments are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

In accordance with aspects of embodiments described and illustrated herein, a solution to the hot-patch uCode update is disclosed that provides an upgradable uCode loader runtime services for bare metal deployment to support runtime update of the uCode loading procedure as well as dynamic load of activation procedure(s) specific to uCode patch and activation policy specific to users. This solution provides several advantages, including enabling cloud service providers to hot-patch the uCode through a standalone uCode loader runtime service in BIOS firmware for bare metal deployment without tenant system involvement. The support of runtime update of uCode loading procedures decouples uCode loading logic from uCode loader framework. This removes dependencies on the uCode loader runtime service when needing to update the uCode loading logic. The capability to dynamically load uCode activation procedure and activation policy significantly eliminates BIOS firmware upgrade cases from uCode activation procedure update.

The solution introduces a patchable uCode loader runtime service in BIOS firmware to support uCode hot-patch for bare metal deployment. To support selective uCode activation scenarios, the uCode loader logic is separated as a uCode loading procedure and deferred uCode activation procedure. The uCode activation procedure allows users to active the required uCode patch functions according to actual needs. Because the uCode activation function is specific to uCode patch version, the activation procedure is defined to be dynamically loadable along with dynamic loading of the user activation policy. Meanwhile, the uCode loading procedure is also patchable in runtime to support the requirement to update the uCode procedure in runtime.

In accordance with an aspect of some embodiments, a uCode patch, uCode activation utility, uCode loading stub handler, and uCode activation policy are encapsulated into a single uCode capsule image. Under one embodiment, the uCode activation utility, uCode loading stub handler and uCode activation policy are provided via optional fields in the uCode capsule image.

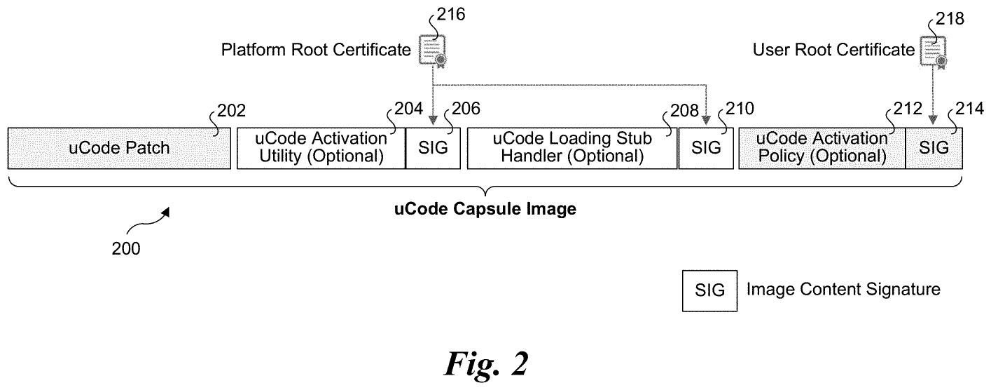

FIG. 2 shows a uCode capsule image 200, according to one embodiment. uCode capsule image 200 includes a uCode patch 202, a uCode activation utility 204 in a first optional field with an image content signature (SIG) 206, a uCode loading stub handler 208 in a second optional field with an image content signature 210, and an optional uCode activation policy 212 in a third optional filed with a signature field 214. In one embodiment, uCode patch 202, uCode activation utility 204, and uCode loading handler 208 are encapsulated into a standard capsule format through a capsule generation tool.

In one embodiment, uCode activation utility 204 and uCode loading stub handler 208 are signed with a platform root certificate 216. uCode activation policy 214 comprises user defined metadata, which can be dynamically appended into uCode capsule image 200 to enable a user to embed the activation policy data. When the user needs to append uCode activation policy 212 into uCode capsule image 200, the user updates image signature field 210 with a platform root certificate 216. The platform root certificate can be owned by either the platform OEM/ODM (original equipment manufacturer or original device manufacturer) or cloud service provider. uCode activation policy 212 is signed with a user root certificate 218 in signature field 214.

In accordance with another aspect, a patchable uCode loader runtime service is defined in BIOS firmware, with three sequential modules: a stub update module, a uCode loading module, and a uCode activation module. There are patchable stubs defined in the uCode loading module and the uCode activation module to support dynamic update of the loading procedure and the activation procedure.

In one embodiment, the uCode loader service is implemented as an SMM (System Management Mode) runtime service in BIOS firmware to execute a uCode hot-upgrade procedure, as well as an activation procedure if the uCode patch needs to defer activation separately from the loading phase. The uCode loader runtime service consists of three sequential modules: patch stub update module to update uCode loading and activation callback functions, uCode loading module to execute uCode update into each core, and uCode activation module to execute deferred activation. The uCode capsule can be transferred to a CPU accessible space through either BIOS SPI (serial peripheral interface) flash or a shared memory buffer.

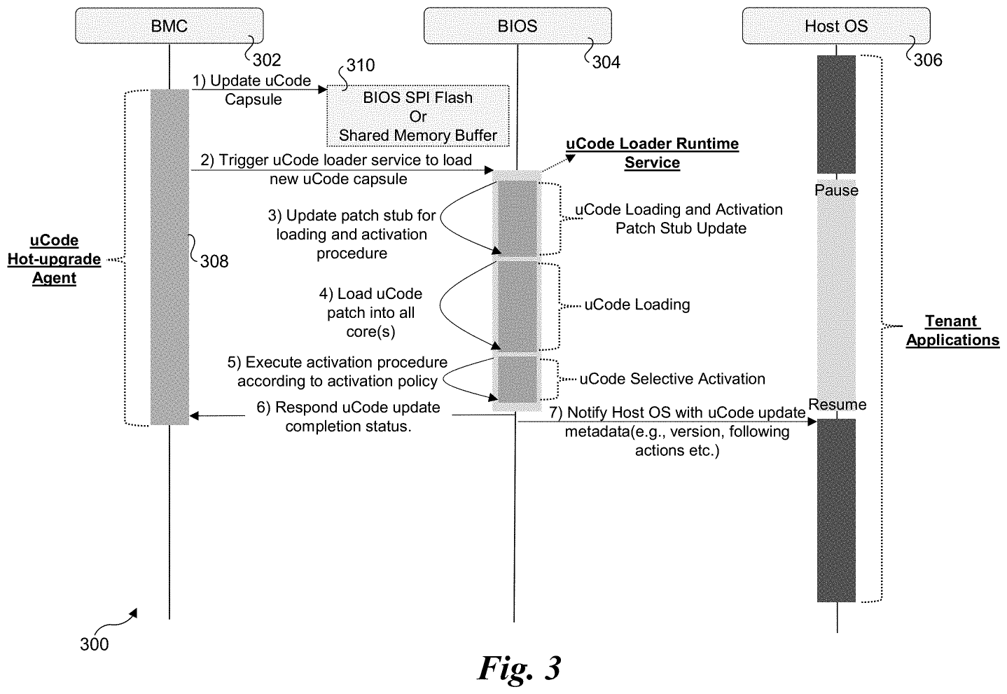

A process flow 300 employing these components is shown in FIG. 3. The process flow involves communication between, and operations performed by a baseboard management controller (BMC) 302, BIOS 304, and a host OS 306. BMC 302 include a uCode hot-upgrade agent 302.

During a first operation, uCode hot-upgrade agent 308 updates the uCode capsule to BIOS accessible region in SPI flash or shared memory 310. In a second operation, uCode hot-upgrade agent 308 triggers the SMM uCode loader runtime service to load and parse the new uCode capsule. This will also launch the SMM uCode loader runtime service, which will pause execution of the host OS and any tenant applications running on the host OS.

The next five operations are performed by a uCode loader runtime service in BIOS 304. During the third operation, if the uCode loader service detects the presence of uCode loader handler and/or uCode activation utility in the uCode capsule, it will update the uCode loading procedure and/or uCode activation procedure with the code logic embedded in uCode capsule. The uCode loader service will then execute the uCode patch to each present core through the uCode loading procedure, as shown by a fourth operation. During the fifth operation, if the uCode loader service detects the deferred activation is required, it will load the activation policy and execute the activation procedure.

During the sixth operation the uCode loader runtime service responds by sending a completion status to uCode update agent 308 in BMC 302. During the seventh operation, the uCode loader runtime service notifies the host operation system through ACPI (in one embodiment) for the uCode update metadata, e.g., uCode update event, version number after update and some uCode patch specific information, e.g., system reset, kernel reload, or enclave teardown etc.

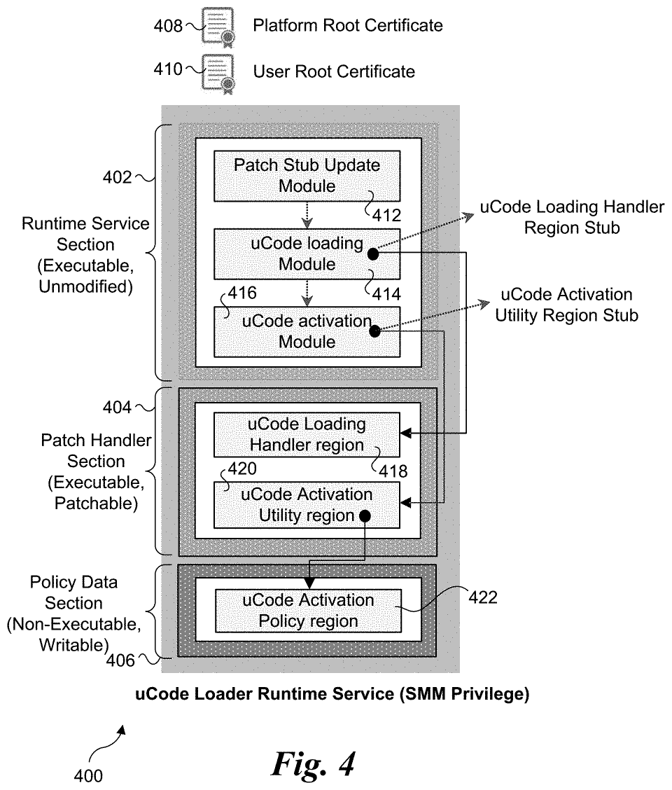

FIG. 4 shows an exemplary structure for a uCode loader runtime service 400. In one embodiment, the uCode loader runtime service runs in an SMM privileged mode and defines three kinds of memory sections: an executable and unmodified runtime service section 402, an executable and patchable patch handler section 404, and an updatable (writable) policy data section 406. Runtime service section 402 uses platform root certificate 408 and user root certificate 410 to authenticate the uCode capsule and update patch handler section 404 and policy data section 506 accordingly.

The runtime service resides in runtime service section 402, and this section is configured as executable and unmodified. Runtime service section 402 includes a patch stub update module 412, a uCode loading module 414 and a uCode activation module 416.

Patch handler section 404 comprises a reserved region in memory to hold the dynamic patch of uCode loading handler and uCode activity handler. This section is executable and patchable, which only allows update request from the patch stub update module when the request is authenticated by platform root certificate 408. Patch handler section 404 includes a uCode loading handler region 418 and a uCode activation utility region 420.

Policy data section 406 is in reserved memory and used to hold user defined activation metadata, which is non-executable. The patch stub update module is able to update the uCode activation policy into this region when the request is successfully authenticated by user root certificate 410. Policy data section 406 includes a uCode activation policy region 422.

As further show in FIG. 4, there are patch handler stubs in uCode loading module 414 and uCode activation module 416 respectively pointing to entry points of uCode loading handler region 418 and uCode activation utility region 420. uCode loading module 414 and uCode activation module 416 invoke these two pointers to call the runtime loaded patch handler.

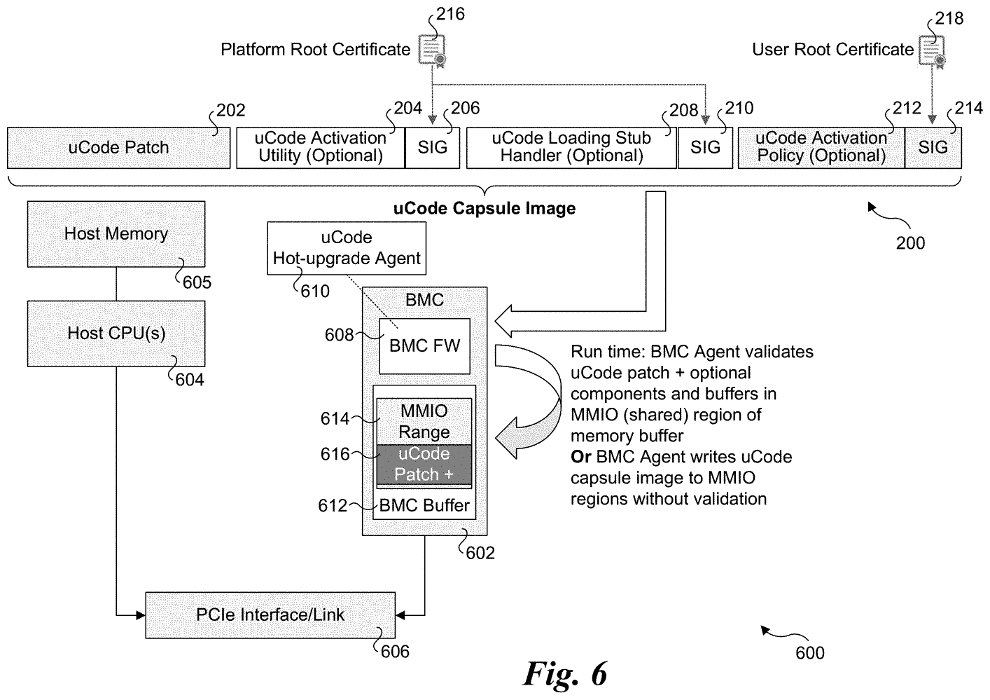

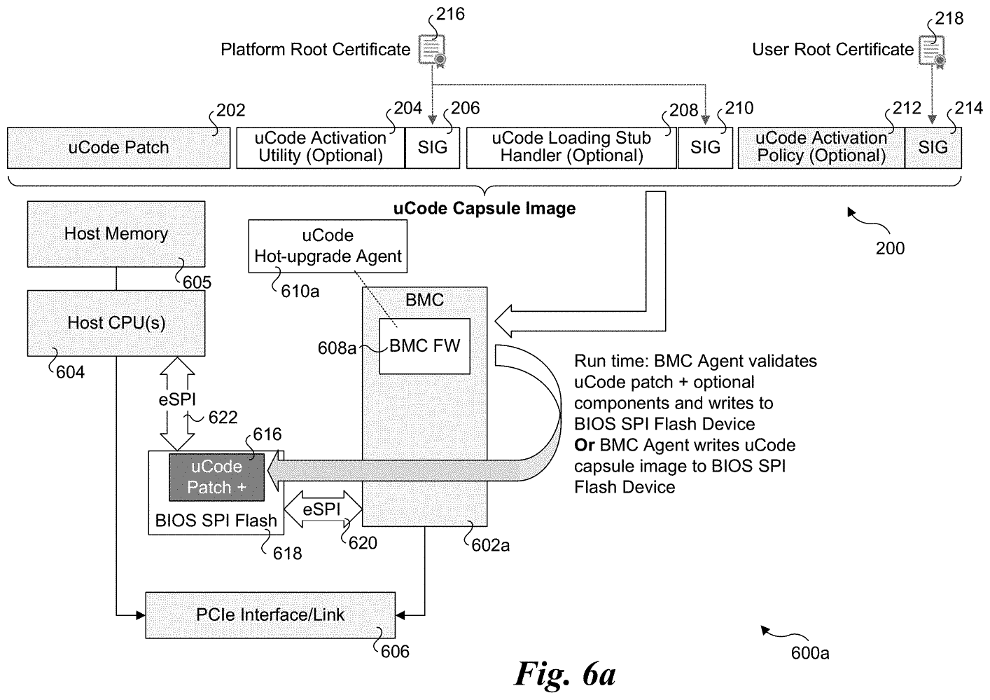

Since the uCode loader runtime service is located at SMM privilege level space, patch stub update module 412 is used to validate the uCode loading handler, the uCode activation utility, and the uCode activation policy with corresponding root certificates before updating these fields into patch handler section 404 and policy data section 406, in one embodiment. As described below with reference to FIGS. 6, 6a, and 7, validation of the uCode loading handler, the uCode activation utility, and the uCode activation policy may be performed at the BMC (e.g., by the uCode hot-upgrade agent).

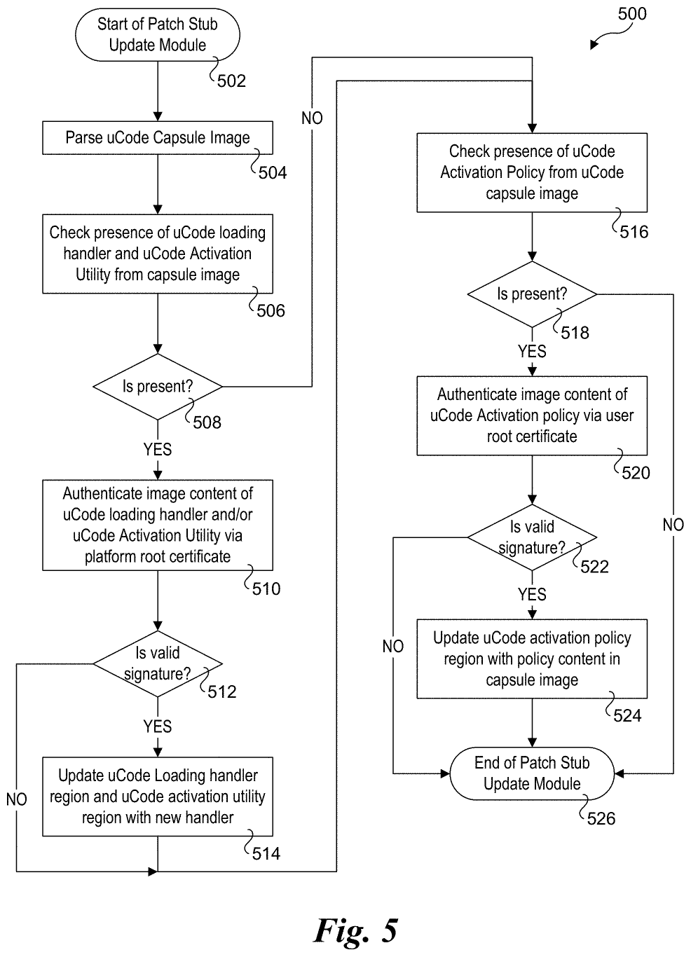

FIG. 5 shows a flowchart 500 illustrating operations and logic for implementing authentication flow for patch stub update module 412. The process begins at a start block 502 representing the start of the patch update module. In a block 502, the uCode capsule image is parsed. In a block 506 the presence of the uCode loading handler and the uCode activation utility for the uCode capsule image is checked. As depicted by a decision block 506, if the uCode loading handler and the uCode activation utility are present, the answer to decision block 506 is YES, and the logic proceeds to a block 510 in which the image content of the uCode loading handler and/or the uCode activation utility is authenticated via the platform root certificate. As shown in a decision block 512, if the signature(s) is/are valid, the logic proceeds to a block 514 in which the uCode loading handler region is updated and the uCode activation utility region is updated with the new handler. The logic then proceeds to a block 516. If either of the answers to decision block 508 or decision block 512 is NO, the logic proceed to block 516 without performing the authentication operation of block 510 or the update operation of block 514.

In block 516, the presence of a uCode activation policy from the uCode capsule image is checked to determine if it is present, with the result shown in a decision block 518. If a uCode activation policy is present, the answer to decision block 518 is YES, and the logic proceeds to a block 520 in which the image content of the uCode activation policy is authenticated via the user root certificate. If the signature is valid, as shown by the YES output of a decision block 522, the uCode activation policy region is updated with policy content for the uCode capsule image. The authentication flow for the patch stub update module is thus completed, as depicted by an end block 526. Returning to decision block 518, if there is no uCode activation policy in the uCode capsule image the answer is NO and the logic proceeds to end block 526.

FIG. 6 shows a diagram 600 illustrating an embodiment of a uCode hot-upgrade method used to update uCode in one or more host CPUs 208 using an out-of-band controller during host OS runtime. The hardware components include a BMC 602 coupled to one or more host CPUs 604 via a PCIe interface/link 606. The host CPU(s) is/are coupled to host memory 605. BMC 602 includes BMC firmware including a uCode hot-upgrade agent 610 and a BMC buffer 612 comprising on-chip memory. During OS runtime, uCode capsule image 200 is received by BMC 602 using an out-of-band channel such as but not limited to a management network. All or a portion of BMC buffer 602 comprises a Memory-Mapped Input-Output (MMIO) range 614 in which a uCode patch plus other optional code extracted from uCode capsule image 200 (depicted as uCode patch+616) is buffered.

In one embodiment, prior to performing the uCode hot-upgrade, BMC agent 610 validates the integrity of the uCode update package with applicable signature credentials, as discussed above with reference to flowchart 500. For example, a platform root certificate 216 may be validated against credentials that are stored internally in the platform, such as in a secure module or the like (e.g., a trusted platform module (TPM)). In another embodiment, uCode capsule image 200 is written into MMIO range 614 without validation at the BMC (in which case the validation operations would be performed by BIOS, as described above).

MMIO enables code running in host memory 605 and executed by a host CPU 604 to access uCode patch+616 in MMIO range 614 via memory access using one or more PCIe transactions. From the perspective of the executing code, MMIO range 614 appears to be part of the address space of host memory 605.

FIG. 6a shows a diagram 600a illustrating an alternate platform configuration under which uCode capsule 200 is received by a BMC 602a on which BMC firmware 608a is stored and executed. BMC firmware 608a includes uCode hot-upgrade agent 610a, which is used to extract the components comprising uCode patch+616 from uCode capsule image 200 and validate the components as described above with reference to flowchart 500. The validated components are then written to BIOS SPI Flash 618 via an eSPI link 620. Once confirmed is valid, these components are written to a portion of BIOS SPI Flash 618. In the illustrated example, BMC is connected to BIOS SPI Flash 618 via an eSPI link 620. As an alternative, an SPI link may be used. A host CPU 604 the accesses code patch+616 is from BIOS SPI Flash 618 via an eSPI link 620 and executes/loads code patch+616 to complete the uCode hot-upgrade.

As above, in another embodiment, the uCode capsule image is written to BIOS SPI Flash 618 without validation at the BMC. Subsequently, the uCode patch and the optional components will be validated by BIOS, as described above.

In one embodiment the BMC includes an on-chip memory buffer comprising a video frame buffer that is repurposed for buffering the uCode patch plus optional components, such as shown in FIG. 7. Under this configuration, a BMC 700 including BMC firmware 702 and a video frame buffer 704 is coupled to a host CPU 706 via an applicable link such as but not limited to a PCIe link (not shown). During a first operation ‘1’, the BMC receives the uCode capsule image out-of-band and employs its uCode hot-upgrade agent 708 to extract and validate the uCode patch plus optional components and buffer them in part of video frame buffer 704. BMC 700 then triggers an SMI that is received by host CPU 706, as depicted by a second operation ‘2’. In response, during a third operation ‘3’ the uCode loader runtime service reads the uCode patch from video frame buffer 704 and applies to the cores of host CPU 704 using the activation policy (if such is included). A similar scheme may be used to update cores for one or more other CPUs for platforms having multiple CPUs.

In one embodiment, the operations performed during operation ‘3’ are similar to those shown in FIG. 3 and discussed above with video frame buffer 702 comprising the shared memory buffer. In one embodiment, validation of the uCode patch plus the optional components is performed by BIOS (e.g., by the uCode loader runtime service) rather than by the uCode hot-upgrade agent on the BMC.

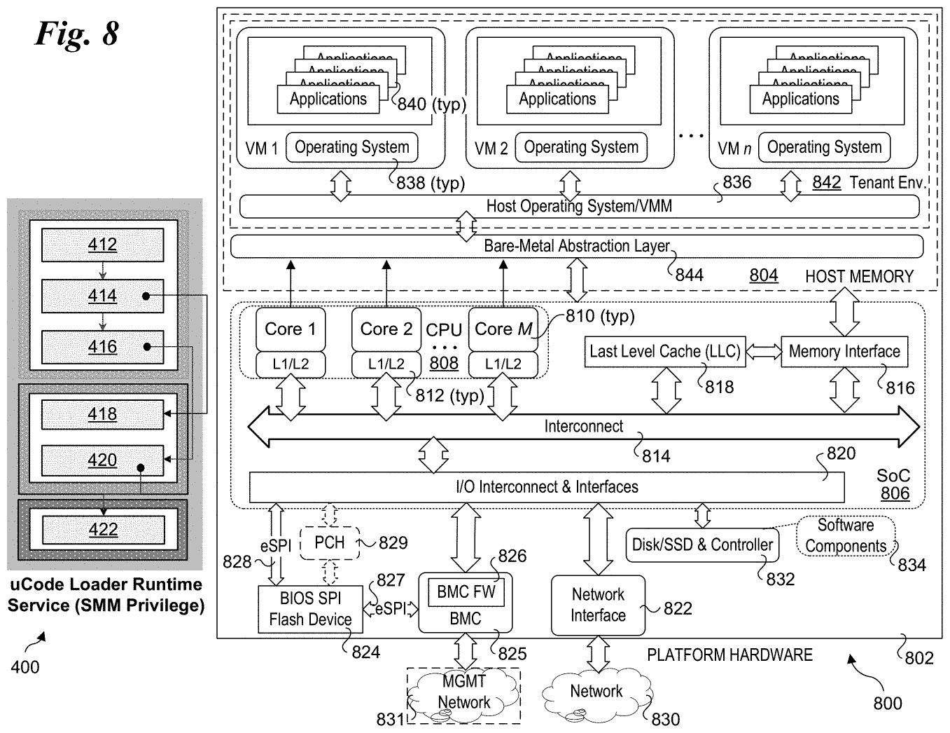

FIG. 8 shows an embodiment of a bare metal cloud platform architecture 800 corresponding to a bare metal platform suitable for implementing aspects of the embodiments described herein. Architecture 800 includes a hardware layer in the lower portion of the diagram including platform hardware 802, and a software layer that includes software components running in host memory 804. Architecture 800 implements uCode loader runtime service 400 using the structure illustrated in FIG. 4 and described above.

Platform hardware 802 includes a processor 806 having a System on a Chip (SoC) architecture including a central processing unit (CPU) 808 with M processor cores 810, each coupled to a Level 1 and Level 2 (L1/L2) cache 812. Each of the processor cores and L1/L2 caches are connected to an interconnect 814 to which each of a memory interface 816 and a Last Level Cache (LLC) 818 is coupled, forming a coherent memory domain. Memory interface is used to access host memory 804 in which various software components are loaded and run via execution of associated software instructions on processor cores 810.

Processor 806 further includes an Input/Output (I/O) interconnect hierarchy, which includes one or more levels of interconnect circuitry and interfaces that are collectively depicted as I/O interconnect & interfaces 820 for simplicity. Various components and peripheral devices are coupled to processor 806 via respective interfaces (not all separately shown), including a network interface 822, a BIOS SPI flash device 824, and a BMC 825 including BMC firmware 826. As shown on the left side of FIG. 8, BIOS SPI flash device 824 has a BIOS flash layout illustrated in diagram 300 and stores firmware and BIOS uCode in the manner discussed above. Generally, the interfaces illustrated in FIGS. 6 and 6a may be used to support communication between processor 806, BIOS SPI flash device 824, and BMC 825, as depicted by eSPI links 827 and 828. As an option, BIOS SPI flash device 824 may be operatively coupled to processor 806 via a platform controller hub (PCH) 829. BMC 825 may also be operatively coupled to processor 806 via PCH 829 (connection path not separately shown. Network interface 822 is connected to a network 830. In some embodiments, BMC 826 is connected to a management network 831 that is separate from network 830. In other embodiments, BMC 826 either is connected to network 830 using a built-in or separate network interface (both not shown) or BMC 826 is configured to communicate with external entities coupled to network 830 via network interface 822.

Platform hardware 802 also includes a disk drive or solid-state disk (SSD) with controller 832 in which software components 834 are stored. Optionally, all or a portion of the software components used to implement the software aspects of embodiments herein may be loaded over a network 830 accessed by network interface 822.

During platform initialization, a current uCode image and various UEFI modules (not separately shown) are loaded into host memory 804 and booted, followed loading and initialization of various software components. The software components include a host operating system and a VM1V1 836 (that would sit above the host operating system but is not shown separately) used to host n virtual machines (VMs) VM 1, VM 2 . . . VM n, each including an operating system 838 on which one or more applications 840 are run. Platform architectures employing containers, such as Docker®-type containers, may be implemented in a similar manner. In addition, non-virtualized computing platforms that only run a single instance of an operating system (e.g., applications run directly on host operating system 836) may also be used.

As further illustrated in FIG. 8, the software components in host memory 804 that include host operating system/VMM 836 and above are part of tenant environment 842. Meanwhile, software components depicted as a bare metal abstraction layer 844 are part of the cloud service provide environment. Generally, the cloud service provider environment will provide mechanisms to support separate access to tenant environment 842 and portions of host memory 804 that are used by the cloud service provider. In some embodiments, the bare metal cloud platform hardware and bare metal abstraction layer are part of a trusted computing base (TCB).

For multi-socket bare metal cloud platforms, the platform architecture would be somewhat similar to that shown in FIG. 8, but with multiple processors (CPUs), each in its own socket, and socket-to-socket interconnects connecting the sockets. Each CPU/socket would also be provided with applicable interfaces to communicate with BIOS SPI Flash device 824 and BMC 825, as well as other IO components.

As used herein, “runtime” and “operating system runtime” refer to an operational phase of a platform following booting of a host operating system. Accordingly, when the host operating system is paused during an out-of-band hot-upgrade process, the host operating system is still in runtime through the process. Moreover, when the host operating system is paused it is unaware of any operations being performed by the CPUs on the bare metal platform and the out-of-band hot-upgrade process provided by the embodiments herein are transparent to the host operating system.

As used herein, “out-of-band” means a communication channel that does not employ communication facilities provided by an operating system, such as a network software stack. As a result, out-of-band communications are implemented separate and apart from communications in the tenant environment involving the host operating system.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

Wwhat is claimed is:

1. A method, comprising:
during runtime operation of a host operating system on a bare metal platform including one or more processing units on which the host operating system and applications are executed,
receiving a microcode capsule image including a microcode patch and one or more of a microcode loading handler, a microcode activation utility, and a microcode activation policy; and
performing a microcode hot-upgrade process to update microcode for at least one of the one or more processing units using the microcode patch, wherein the hot-upgrade process employs the one or more of the microcode loading handler, the microcode activation utility, and the microcode activation policy to effect the hot-upgrade process.

2. The method of claim 1, wherein the uCode hot-upgrade process is transparent to the host operating system.

3. The method of claim 1, wherein the microcode capsule image includes a microcode image handler, further comprising: extracting the microcode image handler from the microcode capsule image; and
loading the microcode patch into multiple cores on a processing unit among the one or more processing units via execution of the microcode loading handler.

4. The method of claim 3, wherein the microcode capsule image further includes an image content signature for authenticating the microcode image handler, further comprising using a platform credential to authenticate the microcode image handler via the image content signature.

5. The method of claim 1, wherein the microcode capsule image includes a microcode activation utility and a microcode activation policy, further comprising:
extracting the microcode patch from the microcode capsule image;
extracting the microcode image handler and the microcode activation policy from the microcode capsule image;
loading the microcode patch into multiple cores on a processing unit among the one or more processing units; and
executing the microcode activation utility to activate one or more selected portion of the microcode patch in the multiple cores on the processing unit in accordance with the microcode activation policy.

6. The method of claim 5, wherein the microcode capsule image further includes an image content signature for authenticating the microcode activation utility, further comprising using a platform credential to authenticate the microcode activation utility via the image content signature.

7. The method of claim 5, wherein the microcode capsule image further includes a second image content signature for the microcode activation policy, further comprising using a tenant credential to authenticate the microcode activation policy via the second image content signature.

8. The method of claim 1, further comprising:
receiving the microcode capsule image at an out-of-band controller;
one of,
writing the microcode patch and the one or more of the microcode loading handler, the microcode activation utility, and the microcode activation policy in a memory buffer in the out-of-band controller; or
writing the microcode capsule image to the memory buffer; and
exposing the memory buffer as a Memory-Mapped Input-Output (MMIO) range to a processing unit.

9. The method of claim 1, further comprising:
receiving the microcode capsule image at an out-of-band controller;
one of,
a) writing the microcode patch and the one or more of the microcode loading handler, the microcode activation utility, and the microcode activation policy to a Flash storage device; or
b) writing the microcode capsule image to the Flash storage device.

10. The method of claim 1, wherein the uCode update service comprises a uCode update System Management Interrupt (SMI) service, and wherein execution of the uCode update SMI service causes the host processor to:
switch the processing unit from a current operational mode to a System Management Mode (SMM), wherein execution of the host operating system is paused while the processing unit is in SMM;
execute the uCode update SMI service while the processing unit is in SMM;
return the processing unit to the current operational mode; and
resume execution of the host operating system.

11. A bare metal platform, comprising:
one or more host central processing units (CPUs);
a memory, coupled to the one or more CPUs,
wherein the bare metal platform is configured to be implemented in a cloud service provider environment and host a tenant environment in which a host operating system and applications are executed on the one or more host CPUs, and wherein the bare metal platform is configured to:
receive a microcode capsule image including a microcode patch and one or more of a microcode loading handler, a microcode activation utility, and a microcode activation policy; and
perform a microcode hot-upgrade process to update microcode for at least one of the one or more CPUs using the microcode patch, wherein the hot-upgrade process employs the one or more of the microcode loading handler, the microcode activation utility, and the microcode activation policy to effect the hot-upgrade process.

12. The bare metal platform of claim 11, wherein the microcode hot-upgrade process is transparent to the host operating system in the tenant environment.

13. The bare metal platform of claim 11, wherein the microcode capsule image includes a microcode image handler, and wherein the bare metal platform is further configured to:
extract the microcode image handler from the microcode capsule image; and
load the microcode patch into multiple cores on a CPU among the one or more CPUs via execution of the microcode loading handler.

14. The bare metal platform of claim 11, wherein the microcode capsule image includes a microcode activation utility and a microcode activation policy, and wherein the bare metal platform is further configured to:
extract the microcode patch from the microcode capsule image;
extract the microcode image handler and the microcode activation policy from the microcode capsule image;
load the microcode patch into multiple cores on a processing unit among the one or more processing units; and
execute the microcode activation utility to activate one or more selected portion of the microcode patch in the multiple cores on the processing unit in accordance with the microcode activation policy.

15. The bare metal platform of claim 11, further comprising a baseband management controller (BMC), operatively coupled to at least one host CPU, wherein the BMC has an on-chip memory buffer and is configured to:
receive the microcode capsule image; and
one of,
a) authenticate the microcode patch and the one or more of the microcode loading handler, the microcode activation utility, and the microcode activation policy and write the authenticated microcode patch and the one or more of the microcode loading handler, the microcode activation utility, and the microcode activation policy to the memory buffer; or
b) write the microcode capsule image to the memory buffer.

16. The bare metal platform of claim 11, further comprising a baseband management controller (BMC), operatively coupled to at least one host CPU, and a Flash storage device, operatively coupled to at least one host CPU and operatively coupled to the BMC, wherein the bare metal platform is further configured to:
receive the microcode capsule image at the BMC; and
one of,
a) authenticate the microcode patch and the one or more of the microcode loading handler, the microcode activation utility, and the microcode activation policy and write the authenticated microcode patch and the one or more of the microcode loading handler, the microcode activation utility, and the microcode activation policy to the Flash storage device; or
b) write the microcode capsule image to the Flash storage device.

17. A non-transitory machine-readable medium have a data structure stored thereon comprising a microcode capsule image including:
a microcode patch;
a microcode activation utility;
a microcode loading stub handler; and
a microcode activation policy.

18. The non-transitory machine-readable medium of claim 17, wherein the microcode capsule image further comprises an image content signature calculated over the microcode activation utility using a platform root certificate.

19. The non-transitory machine-readable medium of claim 17, wherein the microcode capsule image further comprises an image content signature calculated over the microcode loading stub handler using a platform root certificate.

20. The non-transitory machine-readable medium of claim 17, wherein the microcode capsule image further comprises an image content signature calculated over the microcode activation policy using a user root certificate.

21. A method, comprising:
distributing instances of a microcode capsule image to a plurality of bare metal platforms in a data center during runtime operation of host operating systems on the plurality of bare metal platforms, wherein the microcode capsule image includes a microcode patch and one or more of a microcode loading handler, a microcode activation utility, and a microcode activation policy, wherein a bare metal platform includes one or more processors and is configured to process the microcode capsule image to perform a microcode hot-upgrade process to update microcode for at least one of the one or more processing units using the microcode patch, and wherein the hot-upgrade process employs the one or more of the microcode loading handler, the microcode activation utility, and the microcode activation policy to effect the hot-upgrade process.
